(19) United States
(12) Patent Application Publication
(10) Pub. No.: US 2025/0266614 A1
(43) Pub. Date: Aug. 21, 2025

(54) WIRELESS TAG COMMUNICATION APPARATUS, METHOD, AND STORAGE MEDIUM

(71) Applicant: Toshiba Tec Kabushiki Kaisha, Tokyo (JP)

(72) Inventors: Nanami SHINOZAKI, Sunto Shizuoka (JP); Hiroyuki ISHIKAWA, Sunto Shizuoka (JP)

(21) Appl. No.: 18/948,260

(22) Filed: Nov. 14, 2024

(30) Foreign Application Priority Data
Feb. 20, 2024 (JP) 2024-023734

(51) Int. Cl. H01Q 3/12; G06K 19/07

(52) U.S. Cl. CPC H01Q 3/12; G06K 19/0723

(57) ABSTRACT

A wireless tag communication apparatus for communicating with one or more wireless tags attached to one or more articles placed in a placement area on a table includes multiple antennas, a driving device configured to move the multiple antennas such that the antennas draw corresponding parts of a predetermined trajectory, and a reading device configured to perform one reading operation to read information from the one or more wireless tags through the multiple antennas while controlling the driving device to move the multiple antennas along the corresponding parts of the predetermined trajectory.

### CROSS-REFERENCE TO RELATED APPLICATION

This application is based upon and claims the benefit of priority from Japanese Patent Application No. 2024-023734, filed Feb. 20, 2024, the entire contents of which are incorporated herein by reference.

### FIELD

Embodiments described herein relate generally to a wireless tag communication apparatus, a method, and a storage medium.

### BACKGROUND

In recent years, wireless tags have been increasingly used in place of bar codes that have been used in the past for payment processes.

In a system using wireless tags, each wireless tag is attached to an article, the wireless tag is detected by a wireless tag communication apparatus, and information is read from the wireless tag. When receiving an electromagnetic wave, the wireless tag transmits an electromagnetic wave in response to the received electromagnetic wave. The wireless tag communication apparatus moves an antenna that transmits an electromagnetic wave, receives an electromagnetic wave transmitted from a wireless tag in response to the transmitted electromagnetic wave, thereby detects the wireless tag, and reads information from the wireless tag.

A wireless tag communication apparatus is preferably capable of quickly reading information from wireless tags.

### SUMMARY OF THE INVENTION

Embodiments of the present disclosure provide a wireless tag communication apparatus, a method, and a storage medium that make it possible to quickly read information from wireless tags.

An aspect of the present disclosure provides a wireless tag communication apparatus for communicating with one or more wireless tags attached to one or more articles placed in a placement area on a table. The communication apparatus comprises: multiple antennas; a driving device configured to move the multiple antennas such that the antennas draw corresponding parts of a predetermined trajectory; and a reading device configured to perform one reading operation to read information from the one or more wireless tags through the multiple antennas while controlling the driving device to move the multiple antennas along the corresponding parts of the predetermined trajectory.

### BRIEF DESCRIPTION OF THE DRAWINGS

FIG. 1 is a block diagram illustrating an example of a configuration of a wireless tag communication apparatus according to an embodiment.

FIG. 2 is a block diagram illustrating an example of a configuration of a reading device illustrated in FIG. 1.

FIG. 3 is a side view schematically illustrating an example of a configuration of a wireless tag communication apparatus according to a first embodiment.

FIG. 4 is a plan view schematically illustrating an example of a configuration of the wireless tag communication apparatus according to the first embodiment.

FIG. 5 is a plan view schematically illustrating an example of a configuration of a wireless tag communication apparatus according to a first variation of the first embodiment.

FIG. 6 is a plan view schematically illustrating an example of a configuration of a wireless tag communication apparatus according to a second variation of the first embodiment.

FIG. 7 is a side view schematically illustrating an example of a configuration of a wireless tag communication apparatus according to a second embodiment.

FIG. 8 is a side view schematically illustrating an example of a configuration of a wireless tag communication apparatus according to a third embodiment.

### DETAILED DESCRIPTION

Hereinafter, embodiments will be described in detail with reference to the drawings. The present invention is not limited to the embodiments described below.

### Wireless Tag Communication Apparatus

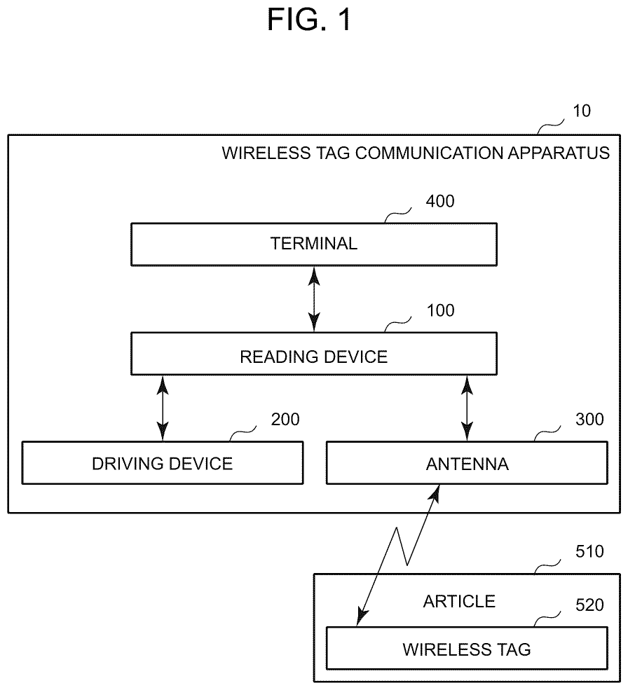

First, a wireless tag communication apparatus 10 according to an embodiment will be described with reference to FIG. 1. FIG. 1 is a block diagram illustrating an example of a configuration of the wireless tag communication apparatus 10 according to the embodiment.

The wireless tag communication apparatus 10 determines whether a wireless tag 520 attached to an article 510, such as a commodity, is within a predetermined range, reads information from the wireless tag 520 that is within the predetermined range, and processes the read information.

FIG. 1 shows one article 510 and one wireless tag 520 for convenience. However, there may be any number of articles 510 and any number of wireless tags 520. One wireless tag 520 is attached to each article 510.

The wireless tag communication apparatus 10 includes a reading device 100, a driving device 200, an antenna 300, and a terminal 400.

The reading device 100 controls the driving device 200 and the antenna 300 to read information from the wireless tag 520. An example of a configuration of the reading device 100 will be described later.

The driving device 200 moves the antenna 300. An example of a configuration of the driving device 200 will be described later.

The antenna 300 communicates with the wireless tag 520. The antenna 300 emits an electromagnetic wave. Also, the antenna 300 receives an electromagnetic wave that is transmitted from the wireless tag 520 in response to the emitted electromagnetic wave. The antenna 300 converts the electromagnetic wave received from the wireless tag 520 into a radio frequency signal, and outputs the radio frequency signal to the reading device 100.

The terminal 400 processes information read from the wireless tag 520 by the reading device 100. The terminal 400 is, for example, a personal computer (PC). However, the terminal 400 is not limited to a PC but may be any device that can process information.

The wireless tag 520 is typically a radio frequency identification (RFID) tag. The wireless tag 520 may be another type of wireless tag. The wireless tag 520 is a passive wireless tag that operates using a radio wave transmitted from the antenna 300 as an energy source. The wireless tag 520 performs backscatter modulation on an unmodulated signal, thereby transmitting a signal including information stored in the wireless tag 520. For example, the information stored in the wireless tag 520 includes unique identification information. For example, the information stored in the wireless tag 520 includes information about the article 510 to which the wireless tag 520 is attached.

### Reading Device

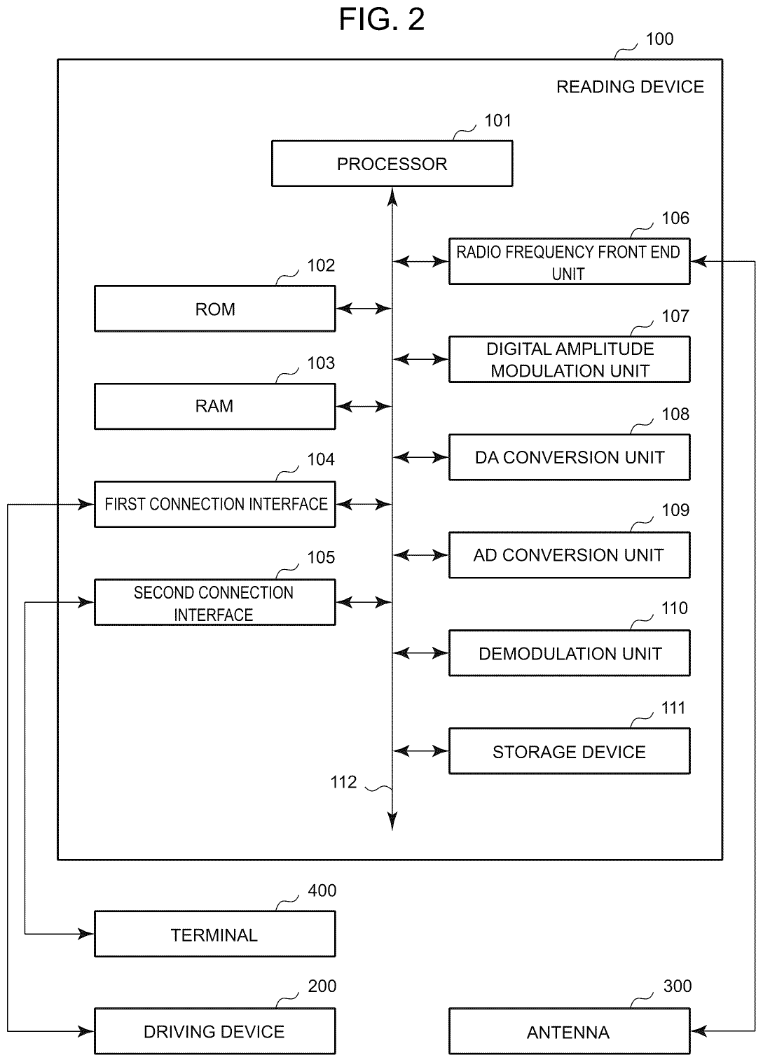

Next, the reading device 100 will be described with reference to FIG. 2. FIG. 2 is a block diagram illustrating an example of a configuration of the reading device 100.

The reading device 100 includes a processor 101, a read-only memory (ROM) 102, a random-access memory (RAM) 103, a first connection interface 104, a second connection interface 105, a radio frequency front end unit 106, a digital amplitude modulation unit 107, a digital-to-analog (DA) conversion unit 108, an analog-to-digital (AD) conversion unit 109, a demodulation unit 110, and a storage device 111. These components of the reading device 100 can communicate with each other via a bus 112.

The processor 101 corresponds to a central part of a computer that performs, for example, calculation processes and control processes necessary for the operations of the reading device 100. The processor 101 loads various programs stored in the ROM 102, the storage device 111, or the like into the RAM 103. The processor 101 implements various functions necessary for the operations of the reading device 100 by executing the programs loaded into the RAM 103.

The processor 101 may be a central processing unit (CPU), a micro processing unit (MPU), a system-on-chip (SoC), a digital signal processor (DSP), a graphics processing unit (GPU), an application specific integrated circuit (ASIC), a programmable logic device (PLD), a field-programmable gate array (FPGA), or a combination of these devices.

The ROM 102 corresponds to a main storage device of a computer having the processor 101 as a central part. The ROM 102 is a non-volatile read-only memory. The ROM 102 stores programs for causing the processor 101 to implement various functions. The ROM 102 stores, for example, data and various setting values used by the processor 101 to perform various processes.

The RAM 103 corresponds to a main storage device of a computer having the processor 101 as a central part. Data can be read from and written to the RAM 103. The RAM 103 is a work area that temporarily stores data used by the processor 101 to perform various processes.

The first connection interface 104 is used by the reading device 100 to communicate with the driving device 200.

The second connection interface 105 is used by the reading device 100 to communicate with the terminal 400.

The radio frequency front end unit 106 outputs a radio frequency signal to the antenna 300. In addition, the radio frequency front end unit 106 receives a radio frequency signal from the antenna 300.

The digital amplitude modulation unit 107 adds information to a carrier wave to be transmitted to the wireless tag 520.

The DA conversion unit 108 converts a digital signal modulated by the digital amplitude modulation unit 107 into an analog signal. The DA conversion unit 108 outputs a radio frequency signal to the antenna 300 via the radio frequency front end unit 106.

The AD conversion unit 109 converts a radio frequency signal input from the antenna 300 via the radio frequency front end unit 106 into a digital signal.

The demodulation unit 110 extracts various kinds of information from a radio wave received from the wireless tag 520. For example, the demodulation unit 110 extracts a unique identification code stored in the wireless tag 520 from a digital signal obtained by the AD conversion unit 109. Also, when a radio wave is received from the wireless tag 520 via the antenna 300, the demodulation unit 110 extracts, according to known technology, tag data of the wireless tag 520 in time series from the digital signal obtained by the AD conversion unit 109. The tag data is time-series data based on a radio wave received from the wireless tag 520 by the antenna 300. The tag data includes phase data. The phase data indicates the phase of the radio wave received from the wireless tag 520. The tag data includes a received signal strength indicator (RSSI). The RSSI indicates the reception intensity of the radio wave received from the wireless tag 520. The tag data may include both of the phase data and the RSSI.

The storage device 111 is a non-volatile memory that stores data, programs, and the like. The storage device 111 may be, but is not limited to, a hard disk drive (HDD) or a solid state drive (SSD). The storage device 111 stores programs for causing the processor 101 to implement various functions. The storage device 111 also stores data used by the processor 101 to perform various processes.

The processor 101 implements various functions of the reading device 100 by executing programs stored in the ROM 102 or the storage device 111. Here, each of the ROM 102 and the storage device 111 is an example of a non-transitory computer-readable storage medium that stores a program for causing the processor 101 to perform a process. Functions of the reading device 100 include, for example, controlling the movement of the antenna 300 by the driving device 200, controlling communication via the antenna 300, determining the position of the wireless tag 520, reading information from the wireless tag 520, and outputting information to the terminal 400.

### First Embodiment

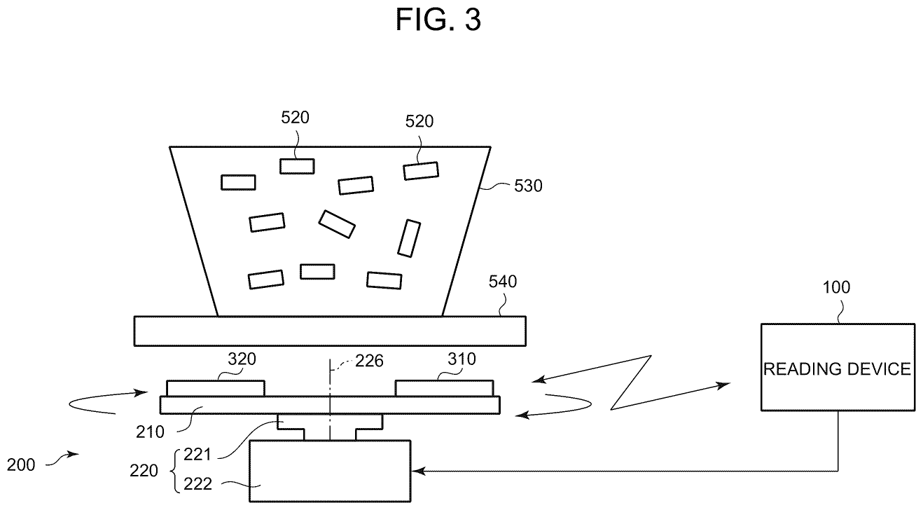

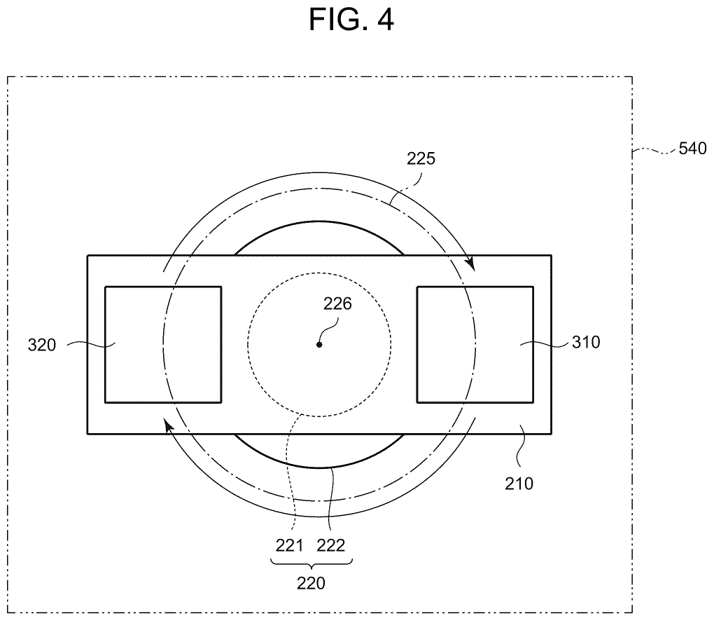

Next, a wireless tag communication apparatus 10 according to a first embodiment will be described with reference to FIG. 3 and FIG. 4. FIG. 3 is a side view schematically illustrating an example of a configuration of the wireless tag communication apparatus 10 according to the first embodiment. FIG. 4 is a plan view schematically illustrating an example of a configuration of the wireless tag communication apparatus 10 according to the first embodiment.

The wireless tag communication apparatus 10 according to the first embodiment includes two antennas 310 and 320. The two antennas 310 and 320 are movably held by the driving device 200. The driving device 200 is disposed under a table 540 on which articles 510 (for example, commodities), to which wireless tags 520 are attached, are placed. That is, the two antennas 310 and 320 are movably disposed under the table 540.

In FIG. 3, the articles 510 are not illustrated, and only the wireless tags 520 are illustrated. Also, the articles 510 and the wireless tags 520 are not shown in FIG. 4.

The table 540 is a plate-like member that is held horizontally. A placement area for the articles 510, such as commodities, is set on the table 540. The articles 510 are recommended to be placed in the placement area. For example, the articles 510 are placed in a basket 530 (e.g., a shopping basket), and the basket 530 is placed in the placement area on the table 540.

The wireless tag communication apparatus 10 reads information from the wireless tags 520 attached to the articles 510. Specifically, the wireless tag communication apparatus 10 reads information from target wireless tags 520 located within the placement area. However, the wireless tag communication apparatus 10 may also read information from non-target wireless tags 520 located outside of the placement area on the table 540. In particular, when non-target wireless tags 520 are located near the placement area, it is highly likely that the wireless tag communication apparatus 10 erroneously reads information from the non-target wireless tags 520.

In order to avoid such erroneous reading, the wireless tag communication apparatus 10 determines whether the wireless tags 520 are within the placement area, sets only the wireless tags 520 within the placement area as target wireless tags 520, and reads information only from the target wireless tags 520.

For example, the wireless tag communication apparatus 10 measures the phase of each wireless tag 520 by moving the antennas 310 and 320 and determines whether the wireless tag 520 is within the placement area based on a phase difference indicating the amount of change in the phase. In another example, the wireless tag communication apparatus 10 moves the antennas 310 and 320 to obtain the tag data of the wireless tag 520 at multiple positions and determines whether the wireless tag 520 is within the placement area by using a trained model that is generated by machine learning using the tag data as input.

For this purpose, the driving device 200 moves the antennas 310 and 320. The driving device 200 includes a stage 210 that holds the antennas 310 and 320 and a moving mechanism 220 that moves the stage 210.

The stage 210 holds the antennas 310 and 320 apart from each other such that the emitting surfaces of the antennas 310 and 320 face the table 540. For example, the stage 210 is a rectangular plate-like member.

The moving mechanism 220 is a rotation mechanism that rotates the stage 210 around a rotation center axis 226. The moving mechanism 220 includes a holder 221 and a motor 222.

The holder 221 holds the stage 210 horizontally. That is, the holder 221 holds the stage 210 in parallel with the table 540. The holder 221 is fixed to the rotation shaft of the motor 222.

The motor 222 rotates the holder 221 around the rotation center axis 226. The rotation center axis 226 is perpendicular to the horizontal plane. That is, the rotation center axis 226 is parallel to the vertical axis. The rotation center axis 226 passes through the midpoint between the two antennas 310 and 320. That is, the rotation center axis 226 passes through the bisection point of a line segment connecting the centers of the two antennas 310 and 320. In other words, the two antennas 310 and 320 are arranged point-symmetrically with respect to the rotation center axis 226 of the motor 222. That is, the two antennas 310 and 320 are arranged at equal angles with respect to the rotation center axis 226 along the circumference of a circle 225 centered on the rotation center axis 226 of the motor 222. In still other words, the two antennas 310 and 320 are arranged at 180-degree intervals around the rotation center axis 226.

The moving mechanism 220 rotates the stage 210 around the rotation center axis 226. As a result, the two antennas 310 and 320 move along the circumference of the same circle 225.

The driving device 200 operates as described below under the control of the reading device 100. In other words, the reading device 100 controls the driving device 200 such that the driving device 200 operates as described below.

The driving device 200 rotates the stage 210 by 180 degrees during each measurement (or one reading operation of reading information from the wireless tags 520 within the placement area). As a result, the antenna 310 moves along the circumference of the circle 225 to a position where the antenna 320 was located before the measurement. The antenna 320 moves along the circumference of the circle 225 to a position where the antenna 310 was located before the measurement. That is, the driving device 200 moves the two antennas 310 and 320 such that the two antennas 310 and 320 draw the corresponding parts of the entire trajectory that needs to be drawn by the two antennas 310 and 320 to perform one reading operation of reading information from the wireless tags 520 within the placement area.

Therefore, it is possible to draw a trajectory corresponding to one round of the circle 225, which needs to be drawn by the antennas 310 and 320 in one measurement, by moving each of the antennas 310 and 320 by a half circumference of the circle 225. That is, with the wireless tag communication apparatus 10 according to the first embodiment, the time required for measurement is half the time required by a wireless tag communication apparatus that performs measurement with one antenna. Accordingly, the wireless tag communication apparatus 10 according to the first embodiment can perform measurement in half the time required by a wireless tag communication apparatus that performs measurement using one antenna. Thus, the present embodiment provides the wireless tag communication apparatus 10 that can quickly read information from the wireless tags 520.

### First Variation

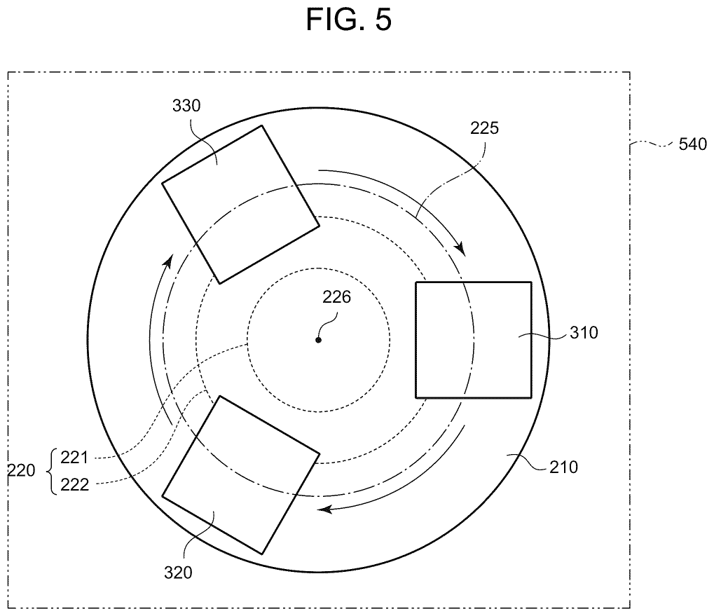

Next, a wireless tag communication apparatus 10 according to a first variation of the first embodiment will be described with reference to FIG. 5. FIG. 5 is a plan view schematically illustrating an example of a configuration of the wireless tag communication apparatus 10 according to the first variation of the first embodiment. The view of FIG. 5 corresponds to the view of FIG. 4. In FIG. 5, as in FIG. 4, the articles 510 and the wireless tags 520 are not shown.

The wireless tag communication apparatus 10 according to the present variation includes three antennas 310, 320, and 330. The three antennas 310, 320, 330 are movably held by a driving device 200 located under the table 540.

The driving device 200 includes a stage 210 that holds the antennas 310, 320, and 330, and a moving mechanism 220 that moves the stage 210.

The stage 210 holds the antennas 310, 320, and 330 apart from each other such that the emission surfaces of the antennas 310, 320, and 330 face the table 540. For example, the stage 210 is a circular plate-like member.

The moving mechanism 220 is a rotation mechanism that rotates the stage 210 around the rotation center axis 226. The configuration of the moving mechanism 220 is described above.

The three antennas 310, 320, and 330 are arranged along the circumference of the circle 225 centered on the rotation center axis 226 of the motor 222 at equal angles with respect to the rotation center axis 226. That is, the three antennas 310, 320, and 330 are arranged at 120-degree intervals around the rotation center axis 226.

The moving mechanism 220 rotates the stage 210 around the rotation center axis 226. As a result, the three antennas 310, 320, and 330 move along the circumference of the same circle 225.

The driving device 200 operates as described below under the control of the reading device 100. In other words, the reading device 100 controls the driving device 200 such that the driving device 200 operates as described below.

The driving device 200 rotates the stage 210 by 120 degrees during each measurement. As a result, the antenna 310 moves along the circumference of the circle 225 to a position where the antenna 320 was located before the measurement. The antenna 320 moves along the circumference of the circle 225 to a position where the antenna 330 was located before the measurement. The antenna 330 moves along the circumference of the circle 225 to a position where the antenna 310 was located before the measurement. That is, the driving device 200 moves the three antennas 310, 320, and 330 such that the three antennas 310, 320, and 330 draw the corresponding parts of the entire trajectory that needs to be drawn by the three antennas 310, 320, and 330 to perform one reading operation of reading information from the wireless tags 520 within the placement area.

Therefore, it is possible to draw a trajectory corresponding to one round of the circle 225, which needs to be drawn by the antennas 310, 320, and 330 in one measurement, by moving each of the three antennas 310, 320, and 330 by one third of the circumference of the circle 225. That is, with the wireless tag communication apparatus 10 according to the present variation, the time required for measurement is only one third of the time required by a wireless tag communication apparatus that performs measurement with one antenna. Accordingly, the wireless tag communication apparatus 10 according to the present variation can perform measurement in one third of the time required by a wireless tag communication apparatus that performs measurement using one antenna. Thus, the present variation provides the wireless tag communication apparatus 10 that can quickly read information from the wireless tags 520.

In the present variation, the three antennas 310, 320, and 330 do not necessarily have to be arranged along the circumference of the circle 225 at equal angles with respect to the rotation center axis 226. The angle formed by a pair of the three antennas 310, 320, and 330 with respect to the rotation center axis 226 may be different from the angle formed by another pair of the three antennas 310, 320, and 330.

For example, the three antennas 310, 320, and 330 may be arranged along the circumference of the circle 225 such that the antennas 310 and 320 form an angle of 90 degrees, the antennas 320 and 330 form an angle of 120 degrees, and the antennas 330 and 310 form an angle of 150 degrees with respect to the rotation center axis 226. In this case, the driving device 200 rotates the stage 210 around the rotation center axis 226 by 150 degrees such that the three antennas 310, 320, and 330 draw the corresponding parts of the entire trajectory that needs to be drawn by the three antennas 310, 320, and 330 to perform one reading operation of reading information from the wireless tags 520 within the placement area. In other words, the antennas 310, 320, and 330 may be arranged at different angles around the rotation center axis 226, and the driving device 200 may move each of the antennas 310, 320, and 330 by the largest one of the different angles around the rotation center axis 226.

### Second Variation

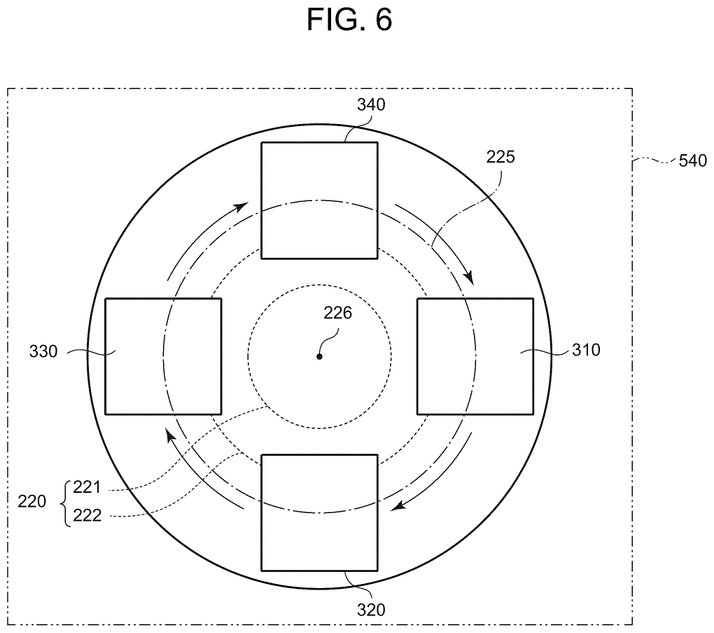

Next, a wireless tag communication apparatus 10 according to a second variation of the first embodiment will be described with reference to FIG. 6. FIG. 6 is a plan view schematically illustrating an example of a configuration of the wireless tag communication apparatus 10 according to the second variation of the first embodiment. The view of FIG. 6 corresponds the view of FIG. 4. In FIG. 6, as in FIG. 4, the articles 510 and the wireless tags 520 are not shown.

The wireless tag communication apparatus 10 according to the present variation includes four antennas 310, 320, 330, and 340. The four antennas 310, 320, 330, 340 are movably held by a driving device 200 located under the table 540.

The driving device 200 includes a stage 210 that holds the antennas 310, 320, 330, and 340, and a moving mechanism 220 that moves the stage 210.

The stage 210 holds the antennas 310, 320, 330, and 340 such that the emission surfaces of the antennas 310, 320, 330, and 340 face the table 540. For example, the stage 210 is a circular plate-like member.

The moving mechanism 220 is a rotation mechanism that rotates the stage 210 around the rotation center axis 226. The configuration of the moving mechanism 220 is described above.

The four antennas 310, 320, 330, and 340 are arranged along the circumference of the circle 225 centered on the rotation center axis 226 of the motor 222 at equal angles with respect to the rotation center axis 226. That is, the four antennas 310, 320, 330, and 340 are arranged at 90-degree intervals around the rotation center axis 226.

The moving mechanism 220 rotates the stage 210 around the rotation center axis 226. As a result, the four antennas 310, 320, 330, and 340 move along the circumference of the same circle 225.

The driving device 200 operates as described below under the control of the reading device 100. In other words, the reading device 100 controls the driving device 200 such that the driving device 200 operates as described below.

The driving device 200 rotates the stage 210 by 90 degrees during each measurement. As a result, the antenna 310 moves along the circumference of the circle 225 to a position where the antenna 320 was located before the measurement. The antenna 320 moves along the circumference of the circle 225 to a position where the antenna 330 was located before the measurement. The antenna 330 moves along the circumference of the circle 225 to a position where the antenna 340 was located before the measurement. The antenna 340 moves along the circumference of the circle 225 to a position where the antenna 310 was located before the measurement. That is, the driving device 200 moves the four antennas 310, 320, 330, and 340 such that the four antennas 310, 320, 330, and 340 draw the corresponding parts of the entire trajectory that needs to be drawn by the four antennas 310, 320, 330, and 340 to perform one reading operation of reading information from the wireless tags 520 within the placement area.

Therefore, it is possible to draw a trajectory corresponding to one round of the circle 225, which needs to be drawn by the antennas 310, 320, 330, and 340 in one measurement, by moving the four antennas 310, 320, 330, and 340 by one fourth of the circumference of the circle 225. That is, with the wireless tag communication apparatus 10 according to the present variation, the time required for measurement is one-fourth of the time required by a wireless tag communication apparatus that performs measurement with one antenna. Accordingly, the wireless tag communication apparatus 10 according to the present variation can perform measurement in one-fourth of the time required by a wireless tag communication apparatus that performs measurement with one antenna. Thus, the present variation provides the wireless tag communication apparatus 10 that can quickly read information from the wireless tags 520.

In the present variation, the four antennas 310, 320, 330, and 340 do not necessarily have to be arranged along the circumference of the circle 225 at equal angles with respect to the rotation center axis 226. The angle formed by an adjacent pair of the four antennas 310, 320, 330, and 340 with respect to the rotation center axis 226 may be different from the angle formed by another adjacent pair of the four antennas 310, 320, 330, and 340. This configuration is similar to that of the second variation, and the detailed description of this configuration is omitted.

### Second Embodiment

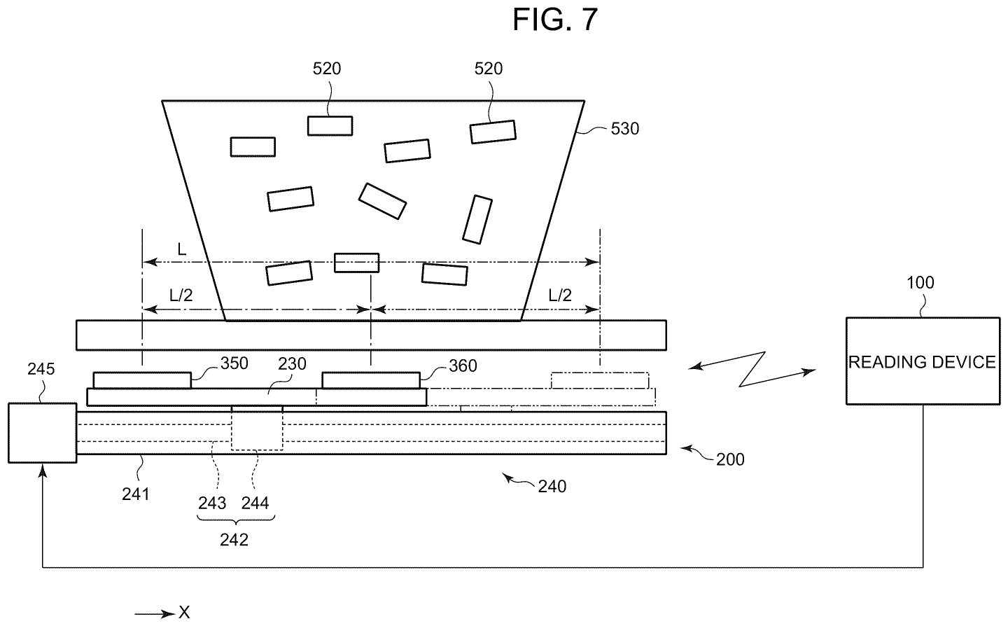

Next, a wireless tag communication apparatus 10 according to a second embodiment will be described with reference to FIG. 7. FIG. 7 is a side view schematically illustrating an example of a configuration of the wireless tag communication apparatus 10 according to the second embodiment. The view of FIG. 7 corresponds to the view of FIG. 3. In FIG. 7, as in FIG. 3, the articles 510 are not shown. Below, differences from the first embodiment are mainly described.

The wireless tag communication apparatus 10 according to the second embodiment includes two antennas 350 and 360. The two antennas 350 and 360 are movably held by a driving device 200 located below the table 540.

The driving device 200 includes a stage 230 that holds the antennas 350 and 360, and a moving mechanism 240 that moves the stage 230.

The stage 230 holds the antennas 350 and 360 such that the emission surfaces of the antennas 350 and 360 face the table 540. For example, the stage 230 is a rectangular plate-like member. The stage 230 holds the antennas 350 and 360 such that the antennas 350 and 360 are spaced apart from each other by a distance L/2 in the X-axis direction in FIG. 7. Here, L/2 is the distance between the centers of the two antennas 350 and 360, and is equal to the stroke of the moving mechanism 240, that is, the distance by which the antennas 350 and 360 are moved by the moving mechanism 240.

The moving mechanism 240 is a linear motion mechanism that linearly moves the stage 230. The moving mechanism 240 includes a guide rail 241 and a motor 245. The guide rail 241 holds the stage 230 such that the guide rail 241 is linearly movable. The moving direction of the stage 230 corresponds to the direction in which the antennas 350 and 360 are separated from each other, that is, the X-axis direction. For example, the guide rail 241 includes a ball screw 242. The ball screw 242 includes a rotatable screw shaft 243 and a nut 244 that is movable along the screw shaft 243 as the screw shaft 243 rotates. The nut 244 holds the stage 230. The motor 245 rotates the screw shaft 243. The rotational movement of the screw shaft 243 is converted into a linear movement of the nut 244.

Therefore, when the motor 245 is rotated, the stage 230 is linearly moved in the horizontal direction (X-axis direction). For example, when the motor 245 is rotated in the forward direction, the stage 230 is linearly moved in the +X direction; and when the motor 245 is rotated in the reverse direction, the stage 230 is linearly moved in the −X direction. That is, the stage 230 is reciprocated in the X-axis direction by changing the rotation direction of the shaft of the motor 245.

The driving device 200 operates as described below under the control of the reading device 100. In other words, the reading device 100 controls the driving device 200 such that the driving device 200 operates as described below.

The driving device 200 moves the stage 230 along the X-axis by the distance L/2 during each measurement. In the example of FIG. 7, the driving device 200 moves the stage 230 in the +X-direction by the distance L/2. In the next measurement, the driving device 200 moves the stage 230 in the −X direction by the distance L/2.

In the example of FIG. 7, the antenna 350 moves to a position where the antenna 360 was located before the measurement. That is, the driving device 200 moves the two antennas 350 and 360 such that the two antennas 350 and 360 draw the corresponding parts of the entire trajectory that needs to be drawn by the two antennas 350 and 360 to perform one reading operation of reading information from the wireless tags 520 within the placement area.

Therefore, it is possible to draw a trajectory with a distance L, which needs to be drawn by the antennas 350 and 360 in one measurement, by moving the two antennas 350 and 360 by the distance L/2. That is, with the wireless tag communication apparatus 10 according to the second embodiment, the time required for measurement is half the time required by a wireless tag communication apparatus that performs measurement using one antenna. Accordingly, the wireless tag communication apparatus 10 according to the second embodiment can perform measurement in half the time required by a wireless tag communication apparatus that performs measurement using one antenna. Thus, the present embodiment provides the wireless tag communication apparatus 10 that can quickly read information from the wireless tags 520.

In the present embodiment, the driving device 200 includes two antennas 350 and 360. However, the driving device 200 may include three or more antennas. In such a case, the stroke can be shortened and the time required for one measurement can be shortened as the number of antennas increases.

### Third Embodiment

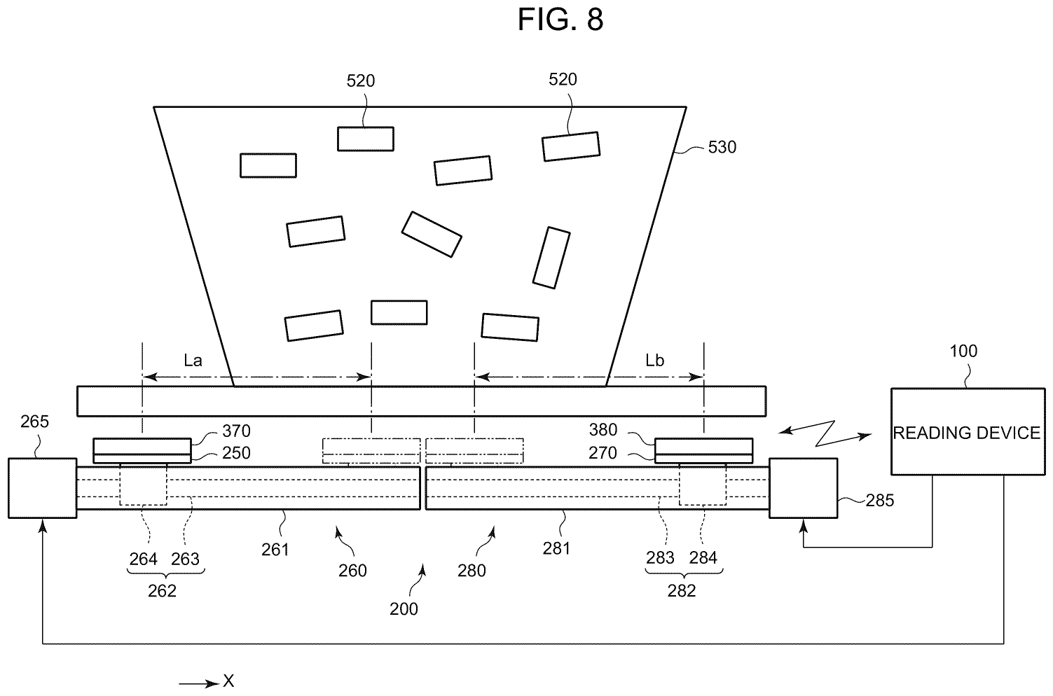

Next, a wireless tag communication apparatus 10 according to a third embodiment will be described with reference to FIG. 8. FIG. 8 is a side view schematically illustrating an example of a configuration of the wireless tag communication apparatus 10 according to the third embodiment. The view of FIG. 8 corresponds to the view of FIG. 7. In FIG. 8, as in FIG. 7, the articles 510 are not shown. Below, differences from the second embodiment are mainly described.

The wireless tag communication apparatus 10 according to the third embodiment includes two antennas 370 and 380. The two antennas 370 and 380 are movably held by a driving device 200 located below the table 540.

The driving device 200 includes a stage 250 that holds the antenna 370, a moving mechanism 260 that moves the stage 250, a stage 270 that holds the antenna 380, and a moving mechanism 280 that moves the stage 270. The antennas 370 and 380 are examples of first and second antennas, the stages 250 and 270 are examples of first and second stages, and the moving mechanisms 260 and 280 are examples of first and second moving mechanisms.

The stage 250 holds the antenna 370 such that the emission surface of the antenna 370 faces the table 540. The stage 270 holds the antenna 380 such that the emission surface of the antenna 380 faces the table 540. For example, the stages 250 and 270 are rectangular plate-like members.

The moving mechanisms 260 and 280 are linear motion mechanisms that linearly move the stages 250 and 270, respectively. The configuration of each of the moving mechanisms 260 and 280 is the same as that of the moving mechanism 240 in the second embodiment.

That is, the moving mechanism 260 includes a guide rail 261 and a motor 265. The guide rail 261 holds the stage 250 such that the stage 250 is linearly movable. The guide rail 261 includes a ball screw 262. The ball screw 262 includes a screw shaft 263 and a nut 264. The nut 264 holds the stage 250. The motor 265 rotates the screw shaft 263. The rotational movement of the screw shaft 263 is converted into a linear movement of the nut 264.

Similarly, the moving mechanism 280 includes a guide rail 281 and a motor 285. The guide rail 281 holds the stage 270 such that the stage 270 is linearly movable. The guide rail 281 includes a ball screw 282. The ball screw 282 includes a screw shaft 283 and a nut 284. The nut 284 holds the stage 270. The motor 285 rotates the screw shaft 283. The rotational movement of the screw shaft 283 is converted into a linear movement of the nut 264.

For example, the moving mechanisms 260 and 280 are arranged such that the rotation center axes of the screw shafts 263 and 283 coincide with each other, and the movement directions of the stages 250 and 270 coincide with each other. Also, the moving mechanisms 260 and 280 are disposed such that the motors 265 and 285 are located outside of the table 540. Furthermore, the moving mechanisms 260 and 280 are arranged such that the ends of the guide rails 261 and 281 are located as close as possible to each other.

La indicates the stroke of the moving mechanism 260, i.e., the distance by which the antenna 370 is moved by the moving mechanism 260. Lb indicates the stroke of the moving mechanism 280, i.e., the distance by which the antenna 380 is moved by the moving mechanism 280. For example, La and Lb are equal to each other. La and Lb may be different from each other.

The moving mechanisms 260 and 280 move the antennas 370 and 380 in synchronization with each other. For example, the moving mechanisms 260 and 280 move the antennas 370 and 380 from outside to inside and from inside to outside. Also, the moving mechanisms 260 and 280 may move the antennas 370 and 380 from right to left and from left to right.

The driving device 200 operates as described below under the control of the reading device 100. In other words, the reading device 100 controls the driving device 200 such that the driving device 200 operates as described below.

In the driving device 200, the moving mechanisms 260 and 280 move the stages 250 and 270 in synchronism with each other along the X-axis during each measurement. As a result, the antennas 370 and 380 move in synchronization with each other. In the example of FIG. 8, the driving device 200 moves the antennas 370 and 380 from outside to inside. Also, during the next measurement, the driving device 200 moves the antennas 370 and 380 from inside to outside.

That is, the driving device 200 moves the two antennas 370 and 380 such that the two antennas 370 and 380 draw the corresponding parts of the entire trajectory that needs to be drawn by the two antennas 370 and 380 to perform one reading operation of reading information from the wireless tags 520 within the placement area.

Therefore, it is possible to draw a trajectory with a distance La+Lb, which needs to be drawn by the antennas 370 and 380 in one measurement, by moving the antennas 370 and 380 by the distances La and Lb, respectively. That is, with the wireless tag communication apparatus 10 according to the third embodiment, the time required for measurement is almost half the time required by a wireless tag communication apparatus that performs measurement using one antenna. Accordingly, the wireless tag communication apparatus 10 according to the third embodiment can perform measurement in approximately half the time required by a wireless tag communication apparatus that performs measurement using one antenna. Thus, the present embodiment provides the wireless tag communication apparatus 10 that can quickly read information from the wireless tags 520.

In the present embodiment, the driving device 200 moves the antennas 370 and 380 such that the antennas 370 and 380 move toward and away from each other. However, the driving device 200 may move the antennas 370 and 380 from right to left and from left to right while keeping the antennas 370 and 380 at a constant distance from each other.

The present disclosure may also be applied to a method performed by the processor 101 of the wireless tag communication apparatus 10 and a non-transitory computer-readable storage medium storing a program for causing the processor 101 of the wireless tag communication apparatus 10 to perform a process. For example, the processor 101 controls antennas to communicate with the wireless tags 520 to read information from the wireless tags 520 and controls the driving device 200 to move the antennas.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A wireless tag communication apparatus for communicating with one or more wireless tags attached to one or more articles placed in a placement area on a table, the communication apparatus comprising:
multiple antennas;
a driving device configured to move the multiple antennas such that the antennas draw corresponding parts of a predetermined trajectory; and
a reading device configured to perform one reading operation to read information from the one or more wireless tags through the multiple antennas while controlling the driving device to move the multiple antennas along the corresponding parts of the predetermined trajectory.

2. The wireless tag communication apparatus according to claim 1, wherein the driving device moves the antennas along a circumference of a same circle.

3. The wireless tag communication apparatus according to claim 2, wherein
the antennas are arranged at equal angles around a center of the circle; and
when N, which is an integer greater than or equal to two, indicates a number of the antennas, the driving device moves each of the antennas by 360/N degrees around the center of the circle.

4. The wireless tag communication apparatus according to claim 2, wherein
the antennas are arranged at different angles around a center of the circle; and
the driving device moves each of the antennas by a largest one of the different angles around the center of the circle.

5. The wireless tag communication apparatus according to claim 1, wherein
the antennas are arranged along one straight line; and
the driving device moves the antennas such that one of the antennas is moved to a previous position of another one of the antennas.

6. The wireless tag communication apparatus according to claim 1, wherein
the antennas are arranged along one straight line; and
the driving device moves each of the antennas along a corresponding part of the straight line at once.

7. The wireless tag communication apparatus according to claim 1, wherein the driving device includes a stage that holds the antennas and a moving mechanism that moves the stage.

8. The wireless tag communication apparatus according to claim 7, wherein
the stage is a rectangular plate-like member that is rotatable around a rotation center axis;
the antennas include two antennas arranged on the stage at 180-degree intervals around the rotation center axis; and
the moving mechanism rotates the stage by 180 degrees around the rotation center axis during the one reading operation.

9. The wireless tag communication apparatus according to claim 7, wherein
the stage is a circular plate-like member that is rotatable around a rotation center axis;
the antennas include three antennas arranged on the stage at 120-degree intervals around the rotation center axis; and
the moving mechanism rotates the stage by 120 degrees around the rotation center axis during the one reading operation.

10. The wireless tag communication apparatus according to claim 7, wherein
the stage is a circular plate-like member that is rotatable around a rotation center axis;
the antennas include four antennas arranged on the stage at 90-degree intervals around the rotation center axis; and
the moving mechanism rotates the stage by 90 degrees around the rotation center axis during the one reading operation.

11. The wireless tag communication apparatus according to claim 7, wherein the moving mechanism includes a holder that holds the stage and a motor that rotates the holder around a rotation center axis.

12. The wireless tag communication apparatus according to claim 7, wherein
the stage is a rectangular plate-like member;
the antennas consist of two antennas that are arranged on the stage and spaced apart from each other by a distance L/2, L indicating a distance of the predetermined trajectory; and
the moving mechanism moves the stage by the distance L/2 during the one reading operation.

13. The wireless tag communication apparatus according to claim 12, wherein the moving mechanism includes a guide rail that holds the stage such that the stage is linearly movable and a motor that moves the stage along the guide rail.

14. The wireless tag communication apparatus according to claim 13, wherein
the guide rail includes a ball screw including a rotatable screw shaft and a nut that holds the stage and is movable along the screw shaft as the screw shaft rotates; and
the motor rotates the screw shaft.

15. The wireless tag communication apparatus according to claim 1, wherein
the antennas include a first antenna and a second antenna; and
the driving device includes
a first stage that holds the first antenna,
a second stage that holds the second antenna,
a first moving mechanism that moves the first stage, and
a second moving mechanism that moves the second stage.

16. The wireless tag communication apparatus according to claim 15, wherein
each of the first stage and the second stage is a rectangular plate-like member; and
the first moving mechanism and the second moving mechanism, respectively, move the first stage and the second stage by a same distance in synchronization with each other.

17. The wireless tag communication apparatus according to claim 16, wherein
the first moving mechanism includes a first guide rail that holds the first stage such that the first stage is linearly movable and a first motor that moves the first stage along the first guide rail; and
the second moving mechanism includes a second guide rail that holds the second stage such that the second stage is linearly movable and a second motor that moves the second stage along the first guide rail.

18. The wireless tag communication apparatus according to claim 17, wherein
the first guide rail includes a first ball screw including a rotatable first screw shaft and a first nut that holds the first stage and is movable along the first screw shaft as the first screw shaft rotates;
the second guide rail includes a second ball screw including a rotatable second screw shaft and a second nut that holds the second stage and is movable along the second screw shaft as the second screw shaft rotates; and
the first moving mechanism and the second moving mechanism are arranged such that a rotation center axis of the first screw shaft coincides with a rotation center axis of the second screw shaft.

19. A method performed by a wireless tag communication apparatus including multiple antennas and a driving device configured to move the multiple antennas such that the antennas draw corresponding parts of a predetermined trajectory, the method comprising:
performing one reading operation to read information from one or more wireless tags attached to one or more articles placed in a placement area on a table through the multiple antennas while controlling the driving device to move the multiple antennas along the corresponding parts of the predetermined trajectory.

20. A non-transitory computer-readable storage medium storing a program for causing a processor to perform a process comprising:
performing one reading operation to read information from one or more wireless tags attached to one or more articles placed in a placement area on a table through multiple antennas while controlling a driving device to move the multiple antennas along corresponding parts of a predetermined trajectory.
